(19) United States
(12) Patent Application Publication
(10) Pub. No.: US 2015/0379890 A1
(43) Pub. Date: Dec. 31, 2015

(54) METHOD OF USING ASTROLOGICAL CHARTS IN THE MEDICAL PRACTICE FOR THE PROPER PROPHYLAXIS OF THE HUMAN BIOLOGICAL AND PSYCHOLOGICAL SYSTEMS

(71) Applicant: Tatiana Galperina Schneider, New York, NY (US)

(72) Inventor: Tatiana Galperina Schneider, New York, NY (US)

(21) Appl. No.: 14/753,750

(22) Filed: Jun. 29, 2015

Related U.S. Application Data
(60) Provisional application No. 62/019,144, filed on Jun. 30, 2014.

(51) Int. Cl. G09B 19/00; G09B 27/04

(52) U.S. Cl. CPC G09B 19/00; G09B 27/04

(57) ABSTRACT

A method of using astrological charts for medical diagnosing and prophylactic treatment of the human biological systems is provided. Through determining various combinations of constellations and astrological signs particular to a person, the method is used to determine the astrological profile of a person, and the resulting recommended prophylactic treatment of that person's biological systems. The method is a new, unified system of approach for diagnostics and treatment of the human biological systems.

This patent application claims priority to provisional patent application Ser. No. 62/019,144, filed on Jun. 30, 2014, which is hereby incorporated by reference in its entirety.

This invention was not made pursuant to any federally-sponsored research and/or development.

### THE FIELD OF INVENTION

The method and system of the present invention relate to the field of medical diagnostics and treatment, more specifically using astrological charts and systems for the prophylactic treatment of the human biological systems.

### BACKGROUND OF THE INVENTION

There are twelve astrological signs in Western Astrology, each representing a 30 degree sector of the ecliptic (the apparent path of the Sun on the celestial sphere): Aries, Taurus, Gemini, Cancer, Leo, Virgo, Libra, Scorpio, Sagittarius, Capricorn, Aquarius and Pisces. These are the group of zodiacal constellations that make a ring around the Earth in space.

There are also four classical elements: Air, Fire, Water, and Earth, each with associated character traits pertaining to the person born under a sign and particular element. Air and Fire are known as the positive polarity signs, and Water and Earth are known as the negative polarity signs. Additionally, each of the four classical elements exhibits one of the three modalities: Cardinal, Fixed and Mutable. The element and modality is the basic sign characterization: Aries is a Cardinal Fire sign for example. Additionally, there are connections between the sites the seven visible ruling “planets” (Mercury, Mars, Venus, Moon, Sun, Jupiter, and Saturn). The combination of these elements and several other characteristics as fully described in the disclosure of this application is a complex system in Western Astrology, which can be determined with respect to any person based on the date of his or her birth.

According to this system, the celestial makeup of a person relates to and determines the human activity in terms of character, expression, and energy patterns. Although numerous astrological systems have been used to determine and predict the character, personal traits, and other characteristics of a person based on the combinations of the constellations and other astrological signs, the system has not been used for medical diagnostics and prophylactic treatment. Currently, there is no unified method that enables analysis, diagnostics, and prophylactic treatment of the human biological systems.

What is needed is a systematic approach to the method of diagnosing, analyzing and prophylactic treatment of people using the existing system of the Western Astrology and the relationships between the constellations, signs and other elements developed in this Application.

### SUMMARY OF THE INVENTION

The present invention addresses the complete lack of a systematic approach to diagnostics and prophylactic treatment of the human biological systems using astrological charts and the astrological makeup of a person.

A method for diagnosing, analyzing and prophylactic treatment of people using astrological charts is provided in this application. The method allows medical practitioners to tap into the extensive universe of information about any given person that is contained in that person's astrological makeup (i.e., the astrological charts as pertaining to that particular person, including the combination of constellations, signs, polarity, modalities, and planets, to name just a few elements of the methodology). Thus, Pisces, for example, is associated with the lymphatic system (sternum, thymus), and Sagittarius is associated with the development of the motor nervous system.

The method of identifying the person's astrological makeup and the knowledge of its relationship to the biological systems and their corresponding constellations gives medical practitioners direct access to the possible way of functioning of the human system because each system has a number of physical illnesses associated with it, as well as a number of possible psychological conditions.

As a short, example summary, the Applicant identified and developed the following relationships and correlations between astrological signs, elements and constellations of the zodiac and the biological systems of the human body, as well as the relationships fully set forth in this Application, including those between signs and particular human organs, glands and bone or cartilage systems. For example, Pisces are the beginning of conscious imitation starts a collective consciousness the beginning of the conscious area of the leg; Aquarius, Capricorn, Sagittarius, are the beginnings of the human systems; Aquarius—Ankles, bone calls, the beginning of capillaries, blood vessel, calves; Capricorn—knee, cartilage, connective tissue, skeleto-muscle system; and Sagittarius—hip, motor neuro-system, kundalini, liver, pituitary, may include different tainted hemotoxic cells. As a further example, the following associations exist: Leo—back, thoracic vertebras; Cancer—the front bone, ribs; Gemini—shoulders, arms, fingers, bones of the chest cage; Taurus and Aries—face, cartilages of the throat; Virgo and Libra—scull, vertebras.

The Applicant calls this method the Galactic Code or Ecliptic Code because the complete astrological makeup of a person determines their physical and emotional characteristics, well-being, and a host of potential physical and psychological problems, which may be addressed with prophylactic treatment pursuant to the method of this application.

### BRIEF DESCRIPTION OF DRAWINGS

The method and system of the present invention will now be described by way of example with reference to the accompanying drawings in which:

FIG. 1 illustrates the zodiac man with the zodiac signs corresponding to the human biological body systems.

### DESCRIPTION OF THE PREFERRED EMBODIMENT

The Applicant has identified and developed the method of diagnostics and prophylactic treatment based on a person's complete astrological chart. It should be noted that the method uses several characteristics reassigned by the Applicant based on the more modern understanding of the human biological systems and their relationship to the astrological makeup of a person.

Table of Contents

### Part 1

Reading the astrological chart using some new techniques.

1. Recognizing the trio combinations of the constellations in the chart.

2. Observation of the crosses formed by the constellations in the astrological chart

3. Reading of the astrological chart as a development of consciousness from below to above.

4. Classification of the groups formed by the constellations in the chart.

5. Reading of the chart using the axis's of the constellations forming a cross.

Using the new reading of the chart in a clockwise direction in a way to understand the interaction of the systems in the human body.

6. Correlation between the elements and the constellations of the Zodiac and the biological systems of the human body.

7. Classification of the constellations regarding to their location around the coded parts of the body.

8. Correspondence between the constellations of the Zodiac and the planets of the Solar system.

9. The 12 constellations and the ruling planets—an overview

### Part 2

10. The use of astronomy of the Solar System to help to understand the evolution of the living system and the development of the glands in the humans.

11. The possible ways of the involvement of the constellations in the construction of the bones.

### Part 3

12. Evaluation of the condition of the human biological and psychological systems through the use of the astrological chart.

13. The methodology of using the new readings of the astrological chart and the personal data (birthday), for the prophylaxis and the systemic development of the biological and psychological systems of the person.

14. The meaning of the constellations.

15. The 12 constellations and the human ecliptic code.

16. The Solar system and the process of evolution.

### Part 1—Reading the Astrological Chart Using Some New Techniques.

1. Recognizing the Trio Combinations of the Constellations in the Chart.

The chart is drawn in the position that the constellation of Cancer is on the top, and the constellation of Capricorn—in the navel. The midheaven passes through 15 degrees of Cancer (the degree of the star Sirius), making the chart symmetrical.

| Fixed—F | Cardinal—C | Mutable—M |
|---|---|---|
| Leo | Cancer | Gemini - on the top |
| Sagittarius | Capricorn-card | Aquarius |
| Virgo | Libra-card | Scorpio |
| Taurus | Aries-card | Pisces |

Cardinal signs are in the center and are forming a cross cardinal cross.

### Exhibit #1

Earth signs are above the horizontal axis, water signs—are below.

### Exhibit #2

Location of the elements in the chart

### Exhibit #3

2. Observation of the Crosses Formed by the Constellations in the Chart.

Locating the cardinal mutable and fixed cross in the chart.

North (up) [symbol] —Cancer

[symbol]

South (down) [symbol] —Capricorn

[symbol]

West (right) [symbol] —Libra

[symbol]

East (left) [symbol] —Aries

[symbol]

Cardinal cross is the “divine” cross. Planets are moving counter clock wise from cardinal to mutable constellation as designed originally.

Constellations are changing in the time clockwise. The change was going from Leo (Egyptian Kingdom), to Aries (Old testimony File), to Pisces (Jesus time), to Aquarius (Our time-New Age).

When Jesus blesses the feet of his disciples in the II era, the clock moves into a new cycle. From Pisces and goes clockwise to the top of the chart.

Mutable signs become leading. The movements start with Pisces and moves now into Aquarius.

Aquarius—next sign after Pisces—initiates the ankles—independence.

The person uses independence to consciously move towards God.

### Exhibit#4

3. Reading of the Astrological Chart as a Development of Consciousness from Below to Above.

Grouping of the planets on the top and bottom of the chart

On the top (North)—

[symbol]

West (Right)

[symbol]

Bottom (South)

[symbol]

East (left)

[symbol]

[symbol]

The growth of the person goes from the bottom constellation to the top, moving clockwise [symbol] —Top constellation

[symbol] —Intermediate axis

[symbol] —On the bottom

### Divisions of the Chart on the Top and Bottom Signs

Bottom

[symbol] —Waters, consciousness

[symbol] —Sex, old consciousness, existing

[symbol] —Lymphatic system (sternum, thymus), new conscious that is coming

Top of the Chart

[symbol] —Earth, human consciousness, directed towards God

[symbol] —Fire—Systems that are helping

[symbol] —Air, Intermediates between Human-God connections

[symbol] —Heavenly waters

The growth comes with the development of the bottom of the chart that leads to changes at the top of the chart.

Top of the chart—upper part of the person

The bottom—lower part, trunk, legs

[symbol] — [symbol] Is an intermediate system.

The relationship between human consciousness. Improving the relationship leads to Godly qualities of the human consciousness. It's in the middles of given divine capacities and human voluntary independent growth.

4. Classification of the Groups Formed by the Constellations in the Chart.

### Groups of Zodiac Constellations.

### Exhibit #5

### States of Mind.

[symbol] Human

[symbol] —Determined

[symbol] —Conscious

### States of Psychic Awareness

[symbol] —Conscious

[symbol] —Determined, Divine

[symbol] —Human

States of Emotion

[symbol] —Human

[symbol] —Determined

[symbol] —Conscious

### Steps of Initiation

[symbol] Conscious

[symbol] —Determined, Divine

[symbol] —Human

The cosmic way counterclockwise is starting with a cardinal sign. Determined.

The cosmic way clockwise is starting with mutable sign.

The First sign initiated to start the movement in a conscious way was Pisces [symbol] .

The initiation of the human kind starts with the human axis in the sign of Aquarius [symbol] .

The mutable (conscious) sign belongs to the triplet of constellations as well as active after the next triplex of constellations. The mutable sign carries blessings further.

The human sign, fixed, independent follows the mutable sign. It needs the effort of a person to activate it in a conscious way.

The divine determined sign follows the human. This is a most difficult sign to make changes by the person on his own, because it contains a divine grace.

[symbol] —Human—Independent parietal of heart, chest

[symbol] —Divine—Stomach, brain

[symbol] —Conscious, mutable masters, cortex-frontal lobe, chest, arms, lungs.

### States of Psychic Awareness

[symbol] —Conscious, (wealth)

[symbol] —Divine (Relationships, kidney)

[symbol] —Human (independent sex organs)

### States of Emotions

[symbol] —Human (independent throat)

[symbol] —Divine (based emotional balance muscle limbic system)

[symbol] —Conscious (lymphatic system)

### States of Imitation

[symbol] —Conscious (hip)

[symbol] —Divine (knee)

[symbol] —Human (independent, ankle, blood vessels)

5. Reading of the Chart Using the Axes of the Constellations that are Forming a Cross.

Using a new reading of the chart in a clockwise direction in a way to understand the interaction of the systems in the human body.

There are 3 axes Earth—water

Those are forming from below to above

2—from water to Earth

1—from Earth to water

Everything on one axis has the same consciousness.

F [symbol] — [symbol] Understanding ones emotional potential realizing and balancing it and giving it a balanced voice.

[symbol] — [symbol] Compassion and its realization into the wealth.

[symbol] — [symbol] The person and his realization into a divine being.

There are 3 axis's Air-Fire, each has a consciousness of support for the growth and transformation of water and earth.

[symbol] — [symbol] Creative potential for human to grow from self-realization to the ability to voice it.

[symbol] — [symbol] Walking from compassion to wealth

[symbol] — [symbol] —Having a balanced emotional relationship for a growth of human consciousness

Fixed [symbol] — [symbol] Creation (creative work))

Determined, divine [symbol] — [symbol] Having balanced relationships and emotional stability

Mutable (conscious) [symbol] — [symbol] Walking for others (movement), big (hips), small (hands)

Divine axis—Emotional realization of self-needs to be established and worked out by the Divine.

This is a cardinal sign.

Initiation of the 3 low constellation.

[symbol] —Independence, generalizations, blood vessels, nervous system.

[symbol] —Cartilage of the human body

[symbol] Motor nervous system, part of a spinal brain. Initiation of metabolism through liver and pituitary gland.

Cardinal—Divine determined system, needs initiation by God.

Human—may be worked on by a human living.

Mutable—Conscious part, needs initiation by a master.

### Mutable Cross

Gemini—Sagittarius axis

Pisces—Virgo axis

Gemini—Sagittarius axis, development of the conscious mind and the conscious states of the body.

Conscious thinking, determines the somatic state of the body—development of the motor nervous system [symbol] sexual development [symbol] and the state of the peripheral vegetative nervous system (12 breathers— [symbol] ), and the wellness state of the body [symbol] , leading to the states of mind.

This way the somatic consciousness of the body [symbol] determines the state of the mind, and the state of emotions, [symbol] throat, [symbol] limbic system, [symbol] and lymphatic system.

Pisces—Virgo axis—The way from the beginning of the compassionate consciousness to the recognizing the wealth of the psychic state consciousness.

Pisces—Virgo way goes through the cross of movement of the soma and mind (Gemini-Sagittarius-axis).

Pisces, the beginning of the consciousness of the body (feet, lymphatic system) develops into the state of wealth of the body (Virgo), which determines the wealth of the mind. When staying stable (heels( ) and having compassion (immunity)—the wealth of the mind comes.

### Exhibit #6

Stages of initiation of the human body (foundational systems for the beginning of life).

[symbol] —Major human system of hyaluronic cartilage and connective tissue to maintain placidity agreement with God. (Created by God) and (Connected to the Earth by Saturn)

[symbol] —Helper system of Air, independent foundation

[symbol] Helper system of Fire, emotional and motor consciousness (possible of the milky gallery with the center in Sagittarius).

Pisces—the beginning of conscious imitation starts a collective consciousness the beginning of the conscious area of the leg.

Aquarius, Capricorn, Sagittarius, are the beginnings of the human systems.

Aquarius—Ankles, bone calls, the beginning of capillaries, blood vessel, calves.

Capricorn—knee, cartilage, connective tissue, skeleto-muscle system

Sagittarius—Hip, motor neuro-system, kundalini, liver, pituitary, may include different tainted hemotoxic cells.

Virgo—initiates the different states (areas) of mind.

Leo, cancer, Gemini

[symbol] —Unconscious mind

[symbol] —Intermediate mind (super conscious)

[symbol] —Conscious mind

The whole action of the mutable cross gives the movement to swastika in the human (conscious) direction clockwise. It requires initiation from limitless consciousness of the lymphatic system in

[symbol]

The action of the cardinal cross initiates the movement of swastika in the divine (counterclockwise) direction, because it starts of the divine mind in [symbol] .

Systems of the mutable cross—the divine beginning in the human—water of [symbol] develops into the highest of the Earth (human) system—Virgo.

Sagittarius acts as a helper of the fire system.

Gemini—as a helper of the Air system

System of the Divine cross—water of the [symbol] starts the movement to the Earth of the human cartilage in [symbol] and helps it to grow (develops melatonin and GSH) differentiates day from night and helps the body to grow.

Libra acts as a helper from Air system.

Aries—As a helper of the fire system help to find balance in relationships to achieve the divine state of mind. Systems of the fixed cross. Axis of Scorpio and Taurus (sexual, throat, energizes). Water and Earth brings to the exit from the Garden of Eden, begins the deception to the human deficiency of the human fixed realm.

### Systems of the Fixed Cross:

Descending to this system (Taurus and Scorpio)—sexual system and the throat system and energies—brings to the exit from the Garden of Eden.

The constellations of the Leo and Aquarius are helping the Water—Earth systems.

Leo—images, Aquarius—independence, research, knowledge. The helper systems help with the creativity to find the right emotional state of the soul and mind.

6. Correlation Between the Elements and the Constellations of the Zodiac, and the Biological Systems of the Human Body.

12 Constellations and their Ruling Planets are Designing 4 Systems of the Human Being.

Fire [symbol] CNS and peripheral motor neuro system.

[symbol] —Divine unconscious [symbol] system belongs to water galaxy.

[symbol] —Human as an individual— [symbol] reflects the divine

[symbol] —Differentiation of the human being from an undefined cell. Includes motor neuro system, sciatic nerve Kundalini, Metabolism—Liver, Hormonal Control—pituitary. [symbol] —Includes the hip, kundalini, bone marrow cells. Liver, pituitary gland.

### Earth

[symbol] —Divine consciousness of the myelin, human brain (cerebellum), Uranus gives Aura sculpt, periosteal digestion, spleen.

[symbol] —Human consciousness—face [symbol] —Includes throat, thymus, kidney, ovaries, sense of touch.

[symbol] —Differentiation for the human and divine consciousness. [symbol] Saturn rules, Knee, hyaluronic cartilage, muscles, skeletal, teeth, and hair.

Air

[symbol]

[symbol] —Divine conscious [symbol] closest to the sun, reflects the conscious part

[symbol] Human as an individual in action [symbol] muscles, medulla oblongata, adrenal glands, of taste, smell.

[symbol] —Unconscious Blood vessels, calves, full feet (metatarsal bones) Uranus allows Aquarius to become conscious and start consciously differentiating to move the feet.

### Water

[symbol] Superconscious—regulated by the other galaxies

[symbol] —Spirituality of the body (pelvis)—sexual organs

[symbol] —Spirituality of the front of the body (lymphatic system, protection.

Standing on one's own heels. Rules feet, instead of knees, allows human being to stand on their feet instead of knee.

### Other Specifies of the 4 Systems of the Body Coded by the Zodiac Constellations and the Planets of the Solar System

Fire—Central Nervous System. Emotional—Motor Nervous System.

Leo [symbol] ruled by sun [symbol] Unconscious CNS—parietal, temporal, occipital areas Heart, spinal cord, and vertebras.

Aries [symbol] Ruled by [symbol] The human consciousness, the human condition of basal ganglia and limbic system. The development of nuclei and their stability is accomplished mostly in childhood.

Sagittarius [symbol] , ruled by [symbol] —starts the development of the higher vertebrates.

Regulation of CBC, Neocortex, Regulation of behavior, fight response. Intrauterine development uterus.

### Air—Neuro Vegetative System

Gemini [symbol] —Conscious mind, responsible for reactions and directing the system ruled by Mercury.

Libra [symbol] —ruled by [symbol] Mars is responsible for 12 nerves coming out of brain, responsible for action and relationships between the body and the organs. Kidneys, adrenal, fight and flight response, may develops in mammals.

Aquarius [symbol] , ruled by Uranus is responsible for the development of blood supply, neuro-vegetative regulations, glands developed by endothelial cells and nerves, spleen.

### Water—Hormonal System

Cancer [symbol] ruled by [symbol] Neptune—responsible for original NS, super conscious—pineal gland (switching the rhythm night and day, response to light growth).

Conscious mind—frontal part. Subconscious—stomach with its secretions, hormonal regulations energy for the whole system.

Scorpio [symbol] , ruled by Pluto—for hormonal regulation for reproduction menstrual cycle starting in mammals.

Pisces [symbol] —ruled by Chiron—for the Interaction of cells with hormonal regulation for protective function.

### Earth—Ligaments Connective Skeletal Muscle System

Capricorn— [symbol] ruled by Saturn—Responsible for initial skeletal muscle system development with the initiation of Saturn in the evolution, vertebra kingdom appear

Taurus— [symbol] ruled by Venus [symbol] —responsible for the cartilage of the throat (gender—depends on adrenals). Thyroid gland is build by Gemini and Jupiter—depends on the pituitary gland [symbol] is responsible for building the muscles.

Virgo— [symbol] ruled by Uranus and Pluto

This is the only constellation the earth signs that is coded by the planets outside of Jupiter. The cerebellum is a brain that is constructed in a different way than Neocortex. Gives the understanding of oneself and building on a personal foundation of self-worth and knowing self as a creator.

Uranus—Bowels, endothelial cells, nervous system, cerebellum

Pluto—a different metabolism igniting mostly through pancreas.

7. Classification of the Constellations Regarding to Their Location Around the Coded Parts of the Body.

### Exhibit #7

Organs belonging to constellations (organ and a secretional gland)

7 Divine systems—3—coding the brain, 4—Human individuality.

Cancer—Pineal, stomach, breasts.

Leo—Unconscious brain, heart, spinal cord, heart.

Gemini—Conscious brain, frontal lobes, thyroid, five senses, hands, fingers, lungs)

Taurus—face of the person, thymus, vocal cords, female sex organs, ovaries.

Aries—Individuality of the person, limbic system, eyes, testicles.

Virgo—Wellness, digestion, intestines, spleen, cerebellum, parathyroid gland.

Libra—nervous regulation of the person, lumbar area of the spinal cord, medulla, oblongata, 12 bothers, kidneys, adrenals, male sexual organs, muscles, sense of smell and taste.

### 5 Constellations for Differentiation (at the Bottom)—2 Water—on the Sides of the Body, 3—Along the Leg.

Scorpio—reproduction. Sexual organs, glands, bowels, excretory organs.

Pisces—Lymphatic system, feet, heel, toes.

Sagittarius—Growth, pituitary gland, kundalini, pelvic area, sacral area of the spinal cord, sciatic nerve, bone marrow, undifferentiated bone marrow cells, liver. Coccyx area of spinal cord.

Capricorn—knee, hyaluronic cartilage, skeletal system, muscle system, skin, hair, teeth.

Aquarius—Ankle, calves, blood vessels—awakening of consciousness (Uranus—trans-Neptunian objects)

8. Correspondence Between the Constellations of the Zodiac and the Planets of the Solar System.

### Exhibit #8

There might be evidence that the planet ruling the constellation might belong to the same element as the constellation. There could be evidenced by the chemical structure of the planets and its correspondence of the chemical nature of the mediators used by the biological system it is coded by(nitrates, sulfates)

There is also a difference in the structure of the planet, which is corresponding to a certain element. Possible way of belonging of the planets to a certain element is:

Neptune, Pluto, Chiron—water

Uranus, Mars, Mercury—Air

Jupiter, Earth, Sun—Fire

Saturn, Venus,—Earth

The constellation of Virgo is coded by the planets outside the solar system, making an exception from the other constellations, belonging to the element Earth.

9. The 12 Constellations and their Ruling Planets—Overview

When the ecliptic of Zodiac is meeting the ecliptic around the human being, it is responsible for the certain parts and organs of the human body.

On a circle diagram where the constellations are lining up along the ecliptic going around the human body, they are lining up in a way, that the person is standing up on his feet with the head up and body turned to the left side.

The 12 constellations are arranged into 3 constellations on the very upper level making a triplet on the top of the human's head.

The other 4 constellations are grouping around the person's face and the back of the head, two of the constellations on each side. They are forming the human individuality constellations. There area 2 constellations on each side of the body—front and back, those are formed by the constellations belonging to the element of water. Last, there are 3 constellations grouping along the joints of the leg—the ankle, the knee and the hip.

The 3 constellations grouped at the top of a person's head are coding the brain—neocortex, and the chest with its organs. Those are the constellations of Leo, Cancer and Gemini.

The 4 human individuality constellations—Taurus, Virgo, Aries and Libra are coding the scull and some parts of the brain.

Libra, which is coding the medulla oblongata at back the head s also descending to the chest, stomach and pelvis and achieving the nervous regulation of the organs. It is responsible for the relationships with the organs and body parts.

The 2 water constellations at the back and at the front of the body are ruling correspondingly the reproductive system (Scorpio) and the protective system, which consists of the multiple highly organized cells and organs. (Pisces). The constellation of Pisces is intermediate between the collective work of the organized independent units and the appearance of the newly organized individual. (Pisces contributes to the appearance of the feet with the 5 toes, which is taking part in the creation of a new independent being).

When moving clockwise, the appearance of the highly organized nervous system (Neocortex created by the planets of the Solar system) gives way to emotional Human consciousness (The constellations of Aries and Taurus, also ruled by the planets of the Solar system). The Human consciousness leads to a specialized integrative work of independent emotional systems engaged on a basis of love and cooperation. This emotional human consciousness of love and cooperation leads to the creation of new independent individual. The appearance of the new individual shows in the leg of his independence (The constellations of Aquarius, Capricorn and Sagittarius). They are representing the new organized systems, that are important for the construction of the structures and psyche of the human body. They are preparing the way for the signs of self-relation and reproduction (The constellation of Scorpio), to the relationship between the individuals based on their maturity (The constellation of Libra) and the overall feeling of prosperity on multiple levels within the individual—wellness, health, prosperity, financial and behavioral independence (The constellation of Virgo).

The constellation of Virgo represents the highest possible achievements of the human being and reflects the possibility of connection between the Human and Divine Realms. It represents the wellness and happiness of the person leads to the higher functioning of the whole being. Virgo is representing the brain—cerebellum, it can direct the energy coming from below—to all the constellations on the front, thus being a transmitter and distributer of the energy. In its development cerebellum starts to be comparable with the other areas of the brain that are of a devine nature, thus bringing the person closer to God. It brings the possibilities of further development along the spiral, as every year it leads to new achievements in the system of each constellation.

The spiral had to be blessed by a Master and was first blessed by Jesus as he blessed his disciples in the constellation of Pisces to be compassionate, teach in a cooperative and loving way. The apostles were able to walk along the axis from the compassion and the immunity of Pisces towards the blessings of the prosperity in Virgo.

From the constellation of Libra there is a link with the front side, along the base of the brain, so the constellations of Libra or Virgo may connect and interact with the constellations of Aries, Taurus and Pisces. Thus when the energy of Kundalini from the low back is raising up, it can switch to the frontal part of the body. The constellation of Virgo that is regulating the wellbeing of the body may be able to consciously regulate the directions of the energy.

When moving counterclockwise, the constellations having a cardinal sign (Cancer, Libra, Capricorn, Aries) are experiencing the Divine readjustment for the better functioning of the system. As we can suppose, as the Human was designed, he might have already had the Divine qualities in using the brain, relationships, achieving his designs in a grateful stand in front of the Divine, having a stable motor-emotional brain of the basal ganglia and limbic system. The cpyraling was coming in the direction from the brain to the psyche of prosperity, to the relationships between people and to a dignified feeling of himself and his emotions.

Those were leading to his grateful compliance and walk in front of the Divine. Those were transferring in the collective work and the creation of the unique human consciousness, face, and the human brain, designed by God. Most of these qualities were presented to a Humanity as a gift.

The 3 constellations at the ankle, knee and hip are representing the systems of the body that are responsible for the differentiations. Those are the first appeared systems that appeared after the functions executed by the water signs.

Aquarius—representing the ankle, with the 7 tarsal bones reflecting the 7 constellations on the top of the human being, 3 of them being the foundation, and 4 others being on top of them. This sign that is belonging to the air element, is representing the neuro-vegetative system, the effective system, carrying the sensitivity, through the vast system of the vessels carrying the sensitive neuron connections. The vessels are permeating the whole body; the system is carrying the knowledge and the independence of the body. The system is regulated by social planet Uranus. Uranus is ruling this different intermittent conscious system, belonging to the air element.

The leading part of the air system is represented by the constellations of the Gemini that is reflecting the conscious mind. Mercury rules it. The constellation of Libra represents the parts of the brain that are performing the afferent regulatory functions of the vegetative nervous system, responsible for the relationships with the organs and the body parts. This is done partly through the vessels and through the smooth muscles of the body. The sign of Libra is ruled by the planet Mars.

It's possible that the planets regulating the constellations belonging to the air element are belonging themselves to this element as per their structure consistency, chemical composition or some other parameters. Same thing pertains to the planets belonging to the other elements. The air system is building the complicated boned of the human being—the chest, shoulders, arms, fingers, metatarsal bones, vertebras, and possibly sculp.

It's possible that the scull itself is build just by the 4 constellations of the human individuality. The constellation of Capricorn is the next sign after Aquarius; it belongs to the Earth element. It is representing the next joint the knee. it's bones, ligaments, the hyaluronic cartilage, the connective tissue. Saturn is the planet that is ruling all these structures and systems in the body. The knee represents the ability of the human being to surrender to the Divine. The element of Earth is representing the structures in the body that are more rigid and inflexible.

The constellation of Sagittarius is the next sign after the sign of Capricorn and it is regulating the next joint in the human body, the main joint that is accomplishing the motor activity in the body, the hip. The sign of Sagittarius is regulating the hip through the sciatic nerve accomplishing the afferent conscious motor activity of the body. Sagittarius is regulating the Kundalini, that is the combined energy of the motor neurons of the body that is collecting at the base of the spine. It is providing the energy for the motor activity as well, regulating the major gland of the body—the liver, the pituitary. It's possible that it is also regulating the precursors of the Red blood cells. Sagittarius is the sign belonging to the Center of the Milky Way Galaxy. It is belonging to the Fire element, which are the element representing our Solar system, which together with the Air element is representing the system that is helping the interaction of the Human and the Divine. Jupiter is ruling the sign of Sagittarius and is the last planet of our Solar system that is coding the Fire system of the human being. The Sagittarius is holding an arrow of differentiation and Kundalini. Sagittarius is representing the system of the low end of the spinal column, possibly starting with the pelvic area where the sciatic nerve is coming out of the spinal vertebrae.

The leading part of the Fire system, represented by the unconscious part of the brain, is coded by the constellation of Leo and is ruled by the Sun of our Solar system. The conscious part of the brain reflecting the conscious emotional part of the human consciousness is represented by the nuclei of the limbic system and of the basal ganglia and is regulated by the constellation of Aries. Earth rules the constellation of Aries and the human consciousness and it is reflected by the moon, that is representing the planet of Earth in the astrological chart.

The main conscious system is represented by the element of Water, which regulated the most ancient first forms of the living beings. It regulated the functions of the first consciousness and digestion, protection and reproduction.

Neptune and the trans-Neptunian objects are coding the Water system.

The sign of the Water element that is belonging to the Central Nervous system is represented by the constellations of Cancer, which is an intermediate system between the conscious and unconscious mind. In itself it may have all the elements of the conscious, unconscious and superconscious mind. It is superconscious, as it is coding the pineal gland, and is regulating the switch between the conscious and unconscious mind represented by two other signs belonging correspondently to air and fire elements—Gemini and Leo. It's also is regulating major hormonal systems, the day-night switch and thee circadian rhythm of the body. The planet Neptune rules it.

Cancer is in the sky in the middle of summer when the sun is in the midheaven, the constellation is pointing towards the most bright star in the sky Serius. In the middle of July, there is a holiday dedicated to the Neptunian festivities

The reproduction and the protective systems, which are represented correspondently by the constellations of Scorpio and Pisces. The trans-Neptunian objects that are including the planet Pluto are ruling them.

The constellation of Taurus is coding the other structures belonging to the element of Earth. It is regulating the cartilage of the neck, the vocal cords, and possibly parts of the face and the bones of the human face, and is ruled by the planet Venus. Venus is also regulating and building the most interesting gland of the human body, responsible for the complex interaction of the highly developed cells of the body—thymus.

The constellation of Virgo reflects the highest achievement of the human being in its ability to approach to the Divine. It regulates the brain. In the Central Nervous System Virgo is representing the cerebellum. The Cerebellum is a highly differentiated part of the brain, the amount of cortex is 3.6 to the Neocortex, and this ratio remains same through evolution in all the living beings. The whole segment of the Cerebellum with the ponds is separate from the brain and is holding on it. The cortex has a unique function to balance not only the motor activity but other highly specialized factors of recognition and behavior and have a highly spiritual role. Virgo is the Diva who is living partly under the Sun, partly in under the celestial spheres. The planets that are very uncommon to the element of earth rule the sign of Virgo—the trans-Neptunian objects, that are ruling the elements of water and the air. Most possibly it is build by the cooperation of Uranus and Pluto.

In this cooperation Uranus is responsible for the psychic aura, usually ascribed tot his planet and neuro-activity. Pluto may be responsible for the metabolism, represented in Virgo by the gland pancreas.

The planets of Uranus and Pluto are lying beyond the social planets, which represent them coding the Divine qualities of the human body. Jupiter is the social planet, and is the last one that is coding the qualities pertaining to the qualities of the Solar system. Saturn is coming next, and is a social planet coding the systems belonging to the human.

The 5 personal planets, Neptune and Pluto, represent the ruling of the seven constellations on the top. Sun rules the unconscious mind of the Neocortex, and is followed by Neptune, which is ruling the superconscious mind, next comes Mercury, the first most close planet to the Sun, that is ruling the conscious part of the Neocortex. It is starting the line of the personal planets coding the human brain.

Venus is coding the human face and throat, earth and moon—human consciousness, the limbic system, and emotional—motor mind. Mars is regulating the base of the head and the medulla oblongata, ruling the afferent neural regulation and the relationships with the body organs and parts, of the body.

Uranus together with Pluto is representing the brain that can be the highest achievement of the human development on its spiritual way, the cerebellum.

The Sun is surrounded in this interaction of the planets by the Uranus with Pluto from one side, and Neptune—from the other side. The personal planets represent the other parts of the human brain.

The intermediate parts of the water system are coded be the trans-Neptunian objects. They as well as the parts that are coded by the social planets can be also coded partly by the helpers—the asteroid belt, belonging to the solar system

### Part 2

10. The Use of Astronomy of the Solar System to Help to Understand the Evolution of the Living Systems and the Development of the Glands in the Human Beings.

Creation of the glands in evolution.

The methodology of using the Solar system structure (and the ballast code to help understand the development of the human glands in the human body in evolution.

Each constellation and the ruling it planet are responsible for creating a gland in the human body. This work is done in a way that the created gland, for the gland to function of the whole body system, especially in many cases to the system that is created by the next constellation and the ruling it planet.

Starting with the constellation of Cancer, ruled by Neptune. This constellation is responsible for the first organisms, which developed in the water. The other constellations involved in the living organisms residing in the water are Pisces and Scorpio. As all the life in water developed outside of the Solar system, those constellations are ruled by tram—Neptunian objects—Chiron and Pluto correspondingly.

The first organisms were mostly engaged in secretional functions and developed the hormonal system of the body. Besides secretion, they were possessing the protective function (Pisces) and reproductive (Scorpio).

Cancer—is involved in building the stomach—the major metabolic organ of the first multi cellular beings. It also provided the sensory cells—neurons and the pineal gland responsible for providing the signals for the day and night.

Pisces—(R—Chiron) involves multiple cells involved in the front of the body in the protection and secreting chemicals to recognize each other for help and interaction (interleukins in the human body).

Scorpio—(R—Pluto) is involved in the reproduction cycle, which is mediated by the sexual hormones for the maturation of the egg, its ovulation and division (mitosis or meiosis in sexual copulation).

The next constellation that came into work was the constellation of Aquarius (R—Uranus). Aquarius builds the organs connected to the neuro-vegetative system vessels carrying neuronal receptors of vegetative neurons system. Those endothelial cells are cooperating further with the protective cells to build the organs (spleen, lymphatic, nodes). Aquarius is helping in creation of multicellular organism, and low vertebrates, most of each are connected with life in water. Uranus is involved in building of parathyroid gland, which is necessary for the work of the next constellation.

Capricorn—Involvement of Uranus in building of the parathyroid gland. First bones to be created before the involvement of Capricorn.

Capricorn (R—Saturn) is using parathyroid hormone in building its major structures, bones, as well as ligaments, muscles, joints. Those structures bring to life skeletal organisms, some of which achieve big dimensions (dinosaurs). Capricorn is involved in secreting synovial fluid, which is used by itself in the creation of the knee as well as, then by the constellation of Sagittarius for building its major construction—the hip joint.

The influence of Sagittarius (R—Jupiter) gives rise to the increased influence of all planets of the solar system. At this stage the living being acquire organs like the liver and neocortex.

With the action of the sign of the Capricorn, the Higher Vertebrates appear. They have big bones, big joints for movement on the earth. The hip joint is maintaining the leg in the vertical position and the belly is rising from the earth and is carried by the legs.

The vertebras are carrying the spinal brain with the energy of kundalini rising from the emptor nuclei at the low end of the brain and giving energy for movements.

Sagittarius is giving rise to the pituitary gland with production of the hormones—Follicular stimulating hormone, oxytocin, prolactin, ACTH. These hormones are used by the next constellation—Scorpio. Scorpio is giving life to living creatures, which use their hormones for the maturation and proliferation. Further the hormones are used for intrauterine reproduction delivery and lactation.

Pituitary gland is also producing thyroid-stimulating hormone (TSH) that is used by the constellation of Gemini (R—mercury) in building of thyroid gland producing thyroxin. The whole control over the hormonal regulation belongs at this stage to Cancer that is regulating the hypothalamus, which is secreting the releasing factors. Cancer is participating in the process of the intrauterine pregnancy and lactation by using the hormone prolactin and secreting milk after the ending of pregnancy. Cancer may have as well control over the basal ganglia that are secreting Dopamine, serotonin, acetylcholine, norepinephrine. Those substances are important for the whole body as well as the different parts of the brain itself. Sagittarius gives fire to a regulated body.

Adreno—corticotrophin (ACTH—adrenocortico-stimulating hormone) produced by the pituitary gland is used by the constellation of Libra.

Libra (R—mars) includes 12 nerves coming from the base of the brain.

Libra is the part of neuro-vegetative system fair system where neural cells participate with their axons to form the neuro connections that are activating the relationships between the body parts and organs. It affects adrenals creating the fight and flight response.

Libra is connected with the development of the mammals, and possibly the primates. It is connected with the appearance of red blood cells (possible as well that it is connected with Sagittarius—liver spleen). Mars has high concentration of 12.

The intrauterine development characterizes tie for the mammals and primates is also developing with the regulation of Libra. Adrenals are participating in the construction of the gender sensitive cartilage of the throat (Adams apple) for the constellation of Taurus. (R—Venus). Both Mars and Venus are participating this way in creating the human voice. Human voice and ability to talk and sing is the prerogative of the human being. Mars is participating to build the cartilage rich in chondroitin—sulfate. The constellation of Taurus (R—Venus) is participating in building the thymus gland that is protecting the throat and becomes the foundation for the collective work of the lymphocytes of the constellation Pisces (R—Chiron). The lymphocytes are cells that in their development are undergoing positive and negative interactions, both for the necessary outcomes in their service for the whole body this way serving as the higher form of love. This form of love is active until sexual maturation of the body when thymus stops its development and disappears and the action shifts to the constellation of Scorpio and the action of the sexual hormones. The constellation of Pisces is creating the interlinks and the many factors that are used by the next constellation Aquarius (Uranus) in the creation of the poetic organs (spleen, lymphatic, nodes). Thus the circa is continuing.

On the upper end on the level of the central nervous system (CNS) the constellation of Aries is lying in between the constellations of Mars and Venus.

The constellation of Aries (Moon) is the carrier of the human consciousness in the emotional motor brain, which is presented by the limbic system and basal ganglia (possibly in the forebrain, diencephalon, possibly other areas). Aries may have responsibility and use the basal ganglia pertaining to the early childhood development, depending on all learning experiences the child is getting from his close family.

The sign of Libra responsible for forming the relationships and the quality of it (neuronal connections) is lying opposite the sign of Aries establishing the quality of knowledge forming in the basal nuclei in the childhood. The interaction of the sexual hormones is expressing (coming from Mars and the moon) itself in the size of the basal nuclei in the thalamus, determining the gender identity and sexual orientation. In homosexual orientation there are signs of developing more neuronal connections coming to this nuclei. The subcortical basal ganglia secreting neurotransmitters serotonin, dopamine, neropinephrin could be belonging to Leo. Depending on the level of maturation of basal ganglia of human consciousness, there is a different level of reward of secretion of those hormones.

The role of Aries is to bring the human consciousness to the highest development by increasing the maturation of the nuclei. Aries gives signals to the whole body by the stimuli from basal ganglia, hippocampus, amygdala, mammillary body and the whole limbic system as well as from the senses of eyes, nose, ears and mouth. The sense of touch is brought in the human consciousness by the interaction with the sign of Libra. Its possible that the development of systems rules by Aries, Taurus is happening on the human level as the development of the systems regulated by Libra can be happening in mammals as well. The systems created by the sign of Taurus are showing unprecedented structure in the human body (thymus), it's development shows only on the stages of the early omnipotent development of the human being and stops with the sexual maturation, when the mature human consciousness prevails. The constellation of Gemini (R—Mercury) presents an unprecedented example of a system in the body acquiring total consciousness over itself. Gemini gives the human being the possibility of consciously determining each step, bringing it to all other systems, being creative, determine his destination.

Gemini, Leo and Cancer are carrying the responsibility of creating the whole higher part of the human body—the chest with its organs.

Gemini is responsible for creating the lungs, ribs, shoulder, arms, and hands. The arms and hands, especially fingers have their own representation in Gemini, which allows it to make any movement of thought to happen right away. When the person does something with the hands (for example working with the clay) any thought come in life right away. On the opposite site Sagittarius (the sign of Sagittarius is located across the Gemini, on the same axis), the movement is produced with the muscles and the energy of the signal brain (Kundalini) and requires other constellations to come in life.

Representation of the systems of these constellations has also separate representations in the brain. Gemini gives also the site of his representation to the face (the constellation of Taurus) allowing it to become conscious with each action of thought right away as well.

Gemini builds the gland thyroid, which is also regulated by the sign of Sagittarius (ruling the pituitary gland). This gland gives the energy for metabolism to the whole body. It helps with the thermo regulation, has effect on the respiratory Centre and cardiovascular activity, thus regulating the basal ganglia and helping Leon in the regulation of the heart.

The constellation of cancer has under its respiratory influence the first basal ganglia regulating the vital body functions. In the human brain it contains a system of ventricles in the brain system and nuclei of the basal ganglia around them. The stomach of a person is a continuation of the ventricle system and represents a system responding to the thoughts unconsciously. The hormones secreted by the stomach mediate emotional eating as a form of responding to emotions. Digestive hormones are serving for producing supply of energy for the whole body. Cancer regulates part of the cortex and the subconscious part of the mind represented possibly by the pineal gland.

The constellation of Leo (R—Sun) is reflecting the unconscious part of the cosmic consciousness. It is coding potential temporal and occipital parts of the brain as well as the heart, and the spinal brain. Leo may have control over the cells of the heart exhibiting the automated control over the heartbeat.

The right acicular myocardiocytes of the heart are secreting a peptide hormone—cardio dilating regulating the vascular smooth muscles. The secretion besides its own regulation may influence the constellation of Virgo influencing the smooth muscle endothelial cells of the cerebellum. The constellation of Virgo (Uranus, Pluto) is the only constellation belonging to the element of Earth and not to the element of water that is ruled by the planets coming from trans-Neptunian objects space and lying beyond Saturn. This is saying that in the highest of appearance (achievement) the human kingdom of God and is not belonging to the Solar system particularly. Saturn, the planet that have started the existence of the person is located in the middle between Neptune and the tram—Neptunian planets representing the kingdom of God and Jupiter representing the Centre of the milky Galaxy and the solar system. Uranus that is coding the oldest part of the brain—the cerebellum with the pond, rules the constellation of Virgo. Uranus is responsible for parts of Nervous system as well as endothelial cells forming the intestines as well as other organs (hemopoetic) Pluto is ruling Uranus as well and is responsible for the secretion of the pancreatic gland and the metabolism through the path of glycolysis giving substrate for functioning of the whole brain. Virgo has been shown to participate not only in the motor function of the brain but in the emotional regulation and many other functions, giving to the persona psychic aura, which is developed by Uranus.

### To Summarize:

Cancer is providing the body with the pineal gland and the stomach as secretory organs. It regulates the vital respiratory center. Mercury is building the thyroid gland (with the help of Jupiter), necessary to provide the energy for the body.

Aries is providing the mediators Serotonin, dopamine, norepinephrine for the emotional support, influencing the human emotional reaction the memory, thermo regulation.

Taurus is building the thymes for its immune protection.

Pisces is using thymus for immune protection of the whole body and secreting multiple interlinks for constructive protective and hem poetic organs like spleen and lymph nodes that are used him for blood differentiation and blood supply.

Aquarius is building the parathyroid gland used him for creating bones and pressures of vertebral. Saturn uses the parathyroid gland for the creation of vertebral column and by bones.

Saturn is secreting the synovial fluid in the knee joint; Jupiter uses synovial fluid secretion for lubrication of its major joint—lim.

Jupiter is building the pituitary gland, which is used by him for secretion of estrogens from the liver. It builds the liver.

Scorpio is responding to the pituitary gland hormones by secreting the sexual hormones and using it in its hormonal cycle.

Libra is responding to the pituitary gland hormones with the secretion of testosterone from adrenals and male sexual organs. Testosterone is used for interaction with the gender-specific thyroid cartilage of Taurus for the proper creation of vocal cords.

Virgo is influenced by all the mediators influencing the neuro-cortex of the cells in Leo, and to the cardio dilating from Leo.

Virgo is building the pancreatic gland and providing itself and the 3 leading constellations of the cortex—Leo, Cancer and Gemini with glucose and the energy through glucoses taking place mostly in the liver.

Virgo is an amazing constellation that is standing near the sun and from all the constellations alone has a human face. It represents Perceptional in myth that is living half-life on Earth, half-life with Pluto in a different kingdom. Being ruled by Uranus and Pluto in its higher appearance, the human have the taste of another kingdom and belonging to a divine realm.

The consciousness of the human in this realm is next to the consciousness of the Sun. Somehow the development of the cerebellum and ponds can present those qualities to a person. The cortex of the cerebellum that is immense in its involuted state can bring amazing functions, transformations.

Leo is supplying the body with multiple mediations and is regulating the cardio vascular system.

Cancer is regulating the respiratory Centre, day and night switch, of functions providing the major digestion organ.

Mercury is supplying energy to the body coming in a different way than glycolysis, through the thyroxin hormone.

11. The Possible Ways of Involvement of the Constellations in the Construction of Different Bones.

The 3 constellations on the top of the head are responsible for the bones of the chest.

Leo—back, thoracic vertebras

Cancer—the front bone, ribs

Gemini—shoulders, arms, fingers, bones of the chest cage

The 4 constellations of the human individuality are responsible for the scull.

Taurus and Aries—face, cartilages of the throat

Virgo and Libra—scull, vertebras

2 lower water constellations:

Scorpio—pelvic area

Pisces—toes

3 constellations of the body systems, located on the leg:

Sagittarius—Hip

Capricorn—knee, skeletal, muscle systems, hyaluronic cartilage

Aquarius—tarso—matatarsal joints

The personal planets and the trans-Neptunian bodies rule the upper 7 constellations and the 2 lower water constellations. The social planets rule the lower 3 constellations.

### Part 3

12. Evaluation of the Condition of the Human Biological Systems through the Use of the Astrological Charts.

Knowledge of the biological systems and their corresponding constellations gives a direct access to the possible way of functioning of the human system. Each system has a number of illnesses associated with it, as well as a number of possible psychological conditions.

The presence of the planets in the sign speaks of certain qualities of the development of these systems. The presence of the planet that is ruling the sign may mostly give beneficial qualities. The presence of the same planet a s a transit gives the temporal beneficial qualities as well.

The presence of the nodes of the moon is very important and tells that those 2 systems are being worked on.

The presence of the sun has a dual effect.

The person may develop the beneficial qualities of the sign and its corresponding biological system, as well as being more sensitive to the negative qualities. The same applies to its equivalent psychological states.

13. The Methodology of Using the New Readings of the Personal Chart and the Personal Data (Birth Date), for the Prophylaxis of the Human Biological Systems.

The constellation where the sun is located (person's birth date) is usually coding a system that is particularly important in person's life, creating for him negative and positive effects. A lot of characteristics of this system are very present in the person's life, as well as their challenges. Awareness of the system with which the person is dealing, its prophylaxis and development is very important. Techniques as meditation on the location, function and other qualities of this system, including the gland that it is producing and its major role for the whole body playing a role on the psychological and physical wellbeing.

The application of the birth sign of the person for recognizing his personality, his type of thinking and the psychosocial possibilities that he prefers and chooses: the birth sign determines a person's temperament from the following: choleric, phlegmatic, sanguinic or melancholic; the element that the birth sign belongs to will determine the person's conflicts in life.

The birth sign determines: collective or individual type of personality; interruptive, logical, passionate or multicolored way of thinking All those are based on the element the birth sign belongs to.

Depending on the two adjacent to the person's Zodiac signs, the person may choose two of the four areas of life where his spirit belongs to: those possibilities are—development of the nervous system and community living (adjacent air element), development of the creative spirit (adjacent fire element), development of the teaching and guiding inclinations (adjacent earth element), and development of generous sharing (adjacent water element).

The north node of the moon also speaks of the system that will play a major role for the person as it develops more.

Of other importance is the presence of a cluster of planets in a constellation, it is also important to take into account and to meditate on a corresponding system in the human body.

The biological system of the person may be more sensitive when the moon is present thee of at the times when the moon is a transit in the sign.

The presence of the sun in the sign raises the meaning of the constellations for the person. It becomes the major tool of assessing the reality. It raises the psychological conflict of the constellation.

### Cancer (Ruler—Neptune)—Pineal Gland, Growth Hormone, Stomach, Cortex.

Represents:

Conscious 9cortex), subconscious (stomach), superconscious (pineal gland)

The person has concerns for the family, friends. He is providing, organizing things for the whole family.

Localization: The top of the head, stomach

Function: Providing, switching priorities for the family, making things happen, making things more conscious or unconscious

Gland: Pineal, stomach

Mantra: I have time and am doing a good job taking care of myself, my family and friends”

Gemini (Ruler—Mercury)—Conscious creative mind.

Frontal lobes, chest, shoulders, arms, hands, lungs.

Action of the thoughts, the action of arms corresponds the energy of thoughts.

The person has thoughts coming one after another and thinks simultaneously about different subjects.

Localization: Frontal lobes, brows, arms, hands, chest

Function: Moving things into action by the energy of thoughts. The arms are having the representation in the same part of the brain that belongs to the sign of Gemini.

Gland: Lungs, thyroid gland.

It has a function of supplying energy for the whole body to prepare it for action.

Mantra: All my thoughts are coming in an organized way.

Taurus (Ruler—Venus)—Throat, face, 4 senses, gender-specific cartilage, vocal cords, thymus.

Person has love for the nature, beauty, and practical

Localization: Face, throat

Function: Practical, enjoying life, sensitive to the surrounding, love arts and beauty

Gland: Thymus

Mantra: I am making things more beautiful by talking about them, My voice is sweet, I am glorifying God.

Aries (Ruler—Moon)—Basal ganglia and the limbic system. Emotional-motor brain. Human consciousness in evolution. 5 senses. Eyes, nose, face.

Represents the human consciousness that wants to rise more.

The person is wondering and trying to find himself.

Localization: Face, eyes, hose

Function: To develop oneself

Gland: Basal ganglia, limbic system, nuclei secreting serotonin, dopamine, norepinephrin

Mantra: I will find myself; discover piece, stability, and spirituality

Pisces (Ruler—Chiron)—Consciousness of past experiences, compassion, remembrance.

Readiness to protect.

Localization: Thymus, lymphatic nodes and vessels. Frontal part of the body. Feet with 5 bones of toes.

Function: Consciousness of remorse, protection, compassion

Gland: Thymus, lymphocytes secreting different interleukins, interaction of cells in the lymphatic nodes and vessels.

Mantra: I am on a path of healing, Every day I am doing something more conscious and healing.

Aquarius (Ruler—Uranus)—Blood vessels, hemopoetic organs 9spleen, bowels, and endothelial cells.

Neuro-vascular afferent vegetative system with neuro receptors.

The person has a general view on things, innovative, accumulating knowledge, trying to learn things.

Localization: Ankles with 7 tarsal bones, Vascular system throughout the body

Function: Knowing things, generalizing, having new experience, new information.

Gland: Parathyroid

Mantra: I can concentrate on my emotions.

Capricorn (Ruler—Saturn)—Hyaluronic cartilage, skeletal-muscle system, knee joint, synovial fluid

The person likes to design things, start projects

Localization: Knee joint, vertebras, ligaments, connective tissue, hyaluronic cartilage

Function: Designing things, being responsible, organizing, supporting, directing things

Gland—glands, producing synovial fluid

Mantra: I am on my knees before the creator

Sagittarius (Ruler—Jupiter)—neuro-motor system, the low end of the spinal cord, the Kundalini energy (coming possibly from the nuclei of motor neurons in the anterior columns of the spinal cord).

Hip joints, thighs, buttocks, sciatic nerve.

Liver, pituitary gland, igniting the metabolic process for the body.

Possibly Red cells precursors.

Localization: Hip area, low part of the spinal cord. Liver, pituitary.

Function: Motor function of the body, Liver and pituitary function.

Gland: Pituitary, liver

Mantra: I have the energy to make a right move; I have many great specializations that I am doing in a right way.

Scorpio (Ruler—Pluto)—Sexual organs, sexual hormones, organs of excretion, uterus.

Struggling with internal emotions depending on the daily stressors and fluctuations of hormones.

Reproduction.

Localization: pelvic area, uterus, ovaries, bladder, external organs.

Function: Dealing with intense circumstances of life, finding piece and harmony, finding the real sense of self

Gland—sexual glands, Bowen, prostate glands

Mantra: I am finding piece to cope with my emotions.

Libra (Ruler—Mars)—Efferent nervous system, 12 nerves coming from the base of the brain (medulla oblongata).

Efferent brunch of the neuro-vegetative nervous system supplying the organs and the smooth muscles. Sympathetic and parasympathetic nervous system, motor nerves coming to the muscles of the face and tongue.

The person is looking to find a right proportion between the relationship to oneself and others, a right proportion of relating to different people and finding a right action to each one.

Localization: Brain stem beyond the pond, medulla oblongata, 12 nerves coming from the base of the brain,

Face, tongue, throat, adrenals

Function: Relationships with organs and body parts. Innervations of the face. Doing things for others, dealing with issues myself—other.

Dealing with other people's emotions.

Gland: Adrenals, testosterone. Building active relationships, male input to the construction of the cartilage of the throat and vocal cords.

Mantra: I give attention to myself and others. I am finding a right way to relate to myself and others.

Virgo (Ruler—Uranus, Pluto)—Cerebellum with the pond, bowels, digestion, metabolism through glycolisis with the help of the pancreas.

Psychic Aura.

The person is able to perceive the state of wellness, physical, psychological, financial, as well as the state and feeling of happiness and wellbeing itself.

Localization: Low back side of the brain (cerebellum) with a portion of brain stem (the pond), intestines, spleen, pancreas

Function: Wellness, health, compassion, friendship, bliss of balancing relationships. The cerebellum is able to balance the energy received and redistribute it among different body systems. (Receives from the low back body systems and redistributes to the face, emotional brain, immune system)

Gland: Pancreatic gland

Mantra: I am doing everything to perceive and enjoy my wellbeing.

Leo (Ruler—Sun)—Parietal, temporal, occipital parts of the brain, spinal column, heart.

The person has creative talents, experiences himself as a creator.

Localization: Top of the head, posterior and lateral parts of the brain, back of the spine, the heart Function—wants to express himself. Knowledge of his own potential. Creative. Wishes to achieve more.

Gland—Atria of the heart secreting cardiodilatin

Mantra: I am achieving something creative with my brain every day.

14. The Meanings of the Constellations:

Water—taking responsibility, bliss of enlightenment, compassion, psychic awareness and recognition.

Conflict—fears, anxiety. Inability to set boundaries.

Earth—enjoyment of showing oneself, balancing things in one's own way, controlling things, redistributing and analyzing things.

Conflict—doing things in one's own way, control, obsessiveness

Fire—emotional life, expansion, energy, creativity, lightening up

Conflict—intense need for self-realization, self-doubt, need to be recognized, doubt in oneself, necessity to accomplish more, self-esteem

Air—Knowledge, Acting to be more thoughtful, thought itself

Conflict—lack of close emotional connection, lack of recognition of needs, not enough action

The Cardinal sign wants to see the results and wants the qualities of the mutable sign.

The Mutable sign wants to know the process and wants the qualities of the Fixed sign. It feels not recognized and lacking the quality of possession.

The Fixed sign is the expression of the process. It has a quality of possession of the quality of the element. The Fixed sign wants to know the beginning and how to start things and get more of this qualities. It feels the lack of the beginning of these qualities to control the process better.

The cardinal sign leads to the Mutable and then to the Fixed. This sequence happens when the chart is read going clockwise.

The meaning of the sign is tightly connected with the ruling planet.

The planet brings a concentrated existential knowledge of the sign.

### Earth Sign—Doing Things

Capricorn—starting projects, designing and doing things on its own, taking responsibility and often is doing and finishing projects for other people.

Capricorn is a happy sign that is enjoying responsibility, accomplishing things for the other people, designing and accomplishing projects.

Planet—Saturn—the essence of controlling things, doing them on one's own,

Conflict—control, repulsing from people having a birthday in the sign of Taurus and doing things in their own way.

Wants of get the results—from the sign of Virgo—being able to distribute things, balance them.

Mantra—I am dedicating things to God, I am standing on my knees and waiting for divine directions

Virgo—Able to see the results of doing things, seeing the detail and distributing things, having a bliss from helping others, feeling joy and bliss of seeing others to do well.

Virgo is happy when he starts observing things more, so things in a fulfilled way, achieving completeness, doing things in a best way and sharing the results with others.

Planet—Uranus and Pluto. Those planets are bringing the essence of doing and completing things an a best way, Pluto carries the essence of recognition and bliss.

Conflict—obsessiveness, anxiety of not accomplishing things completely

Want to resemble Taurus to enjoy things more.

Mantra (to conquer the negative quality coming from the perfectionism)

I am going to enjoy each detail, I am going to enjoy what I can do

Taurus—enjoying and balancing things

Conflict—doing things in their own, have to endure the consequences of this, has to tolerate good and bad coming from it.

Taurus is happy to enjoy things, both good and bad.

Planet—Venus—enjoyment of the process, enjoyment of all that is brought into awareness.

Wants to resemble Capricorn to be able to design more, start more projects.

Possibly wants to resemble Virgo as well, to be able to finalize and give away, distribute things.

That could be a way for Taurus to resolve the conflict.

Maybe the conflict remains because of the way the Fixed sign wants to get more of it to enjoy, and not intending enough to go to the results and resemble the mutable sign.

Mantra: I am on my way to success, tolerating negative and positive that is happening. There is o good or bad.

I am acquiring the qualities of the other signs to learn the relationship to others.

Water signs—recognition of another

Scorpio—enjoying psychic recognition

Coflict—tolerating the consequences of feeling strong emotions and balancing them.

Scorpio is happy to experience blissful feelings of intense intimate feelings, sometimes is getting intense in processing it and in one relationship.

Planet—Pluto

Wants to resemble Cancer in having multiple relationships and extending caring feelings for the family and friends.

To resolve the conflict needs to resemble Pisces in the ways to be compassionate, this way Scorpio will be resolving and stabilizing the feelings.

Mantra: I am enjoying my feelings that knowing them, I can help others with compassion.

Cancer—enjoying relationships with family and friends and supporting others.

Conflict—anxiety because of the necessity to make relationships and acquire close feelings.

Good with close friends. Making relationships as necessary to maintain functions for business.

Cancer enjoys being supportive to friends, family and people he knows.

Planet—Neptune

Wants to resemble Pisces in the ability to console and support.

To resolve the conflict of anxiety, needs to enjoy the intimacy of the relationships—the process, as Scorpio, needs not to be afraid of feelings. This is difficult because it increases the anxiety of the relationship that needs to be even deeper.

Mantra: I am not afraid of projections and deep feelings. I have skills to build relationships.

Pisces—Enjoying the skills of consoling others.

Conflict—It is difficult to make the boundaries, manage time.

Pisces enjoys his skills to console.

Planet—Chiron

Wants to resemble more the Scorpio, to enjoy more the feelings of intimacy in the relationship.

Needs to resemble Cancer to get more connections. This requires the skills to make boundaries.

Mantra: I have skills to console others and preserve my own time as well as keep healthy boundaries.

Air Signs—Thinking of Another

Libra—Managing the Skills of Thinking of Others and Oneself

Conflict—It is difficult to be aware how much to give to each one and oneself.

Pisces feels the necessity to give to other people.

Planet—Mars.

Wants to resemble the Gemini whose thinking is always in process and things about oneself and others are figured out.

Needs to resemble Aqaurius to have more knowledge about everyone.

Aquareius—Enjoying a vast amount of knowledge and the ability to serve.

Conflict—becomes depressed when is connected to people and doesn't have a feeling of serving.

Doesn't develop very close connections to people.

Aquarius is happy to feel good about his knowledge and servicee.

Planet—Uranus.

Wants to resemble Libra in getting more sevice and more people to serve.

Needs to resemble Gemini in ability to use the thinking process to bringing close connections.

Gemini—Enjoying the process of thinking to make close connections, serve and improve the dynamic of the private life.

Conflict—idle thinking, anxiety of not succeeding in life enough.

Gemini enjoys the possibility of thoughtful approach to life.

Planet—Mercury.

Wants to resemble Aquarius in getting more knowledge that could use in thoughts.

Needs to resemble Libra in looking for service.

Fire Sign—Emotional Creator

Aries—Enjoying emotional expressions and ability to wonder who he is

Conflict—becomes too agitated and angry when can't express himself enough.

Feels the necessity to define himself.

Planet—Moon

Wants to resemble Sagittarius in the ability to come to a definition in expanding oneself.

Needs to resemble Leo in maintaining the light and creativity.

Leo—Enjoying the feeling of the light of his own creativity.

Conflict—has to maintain a high level of creativity to maintain a good self-esteem.

Leo enjoys the feeling of his own possibility but can suffer from a low self-esteem as his creativity is not enough or he is not getting enough recognition in the world.

Planet—Sun.

Wants to resemble Aries in constantly looking for emotions and his own definition.

Needs to resemble Sagittarius in having a desirable position and recognition in the world.

Sagittarius—Enjoys the feeling of expansion and the possibilities of expressing himself in the world. Has energy to struggle for a good position and expand his capacities in the world.

Conflict—gets anxious and overwhelmed of the necessity to define himself and use the energy.

Wants to resemble Leo in maintaining his feeling of glory and light.

Needs to resemble Aries in constantly checking the is the expansion going in the right direction.

The signs have different biological structures to go through the experiences so they can't mimic each other and can go only through their own possibilities in defining themselves and resolving the conflicts.

15. The 12 Constellations and the Ruling Planets of the Solar System.

### The Ecliptic Code.

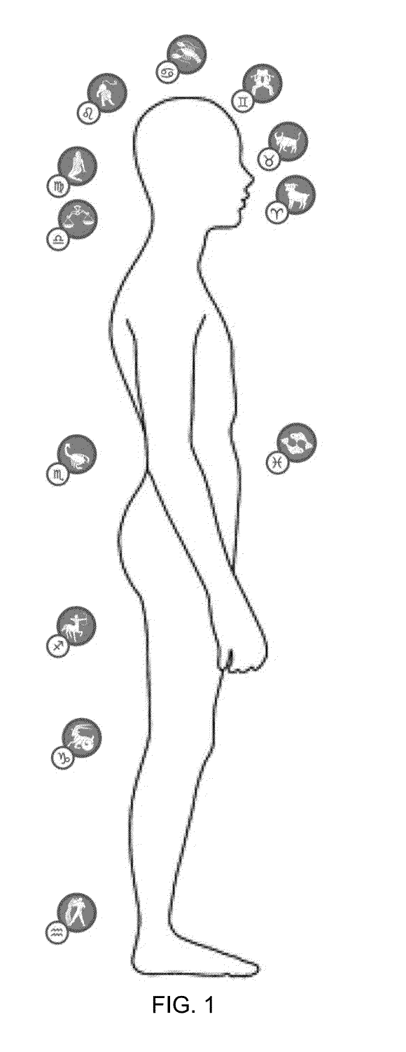

With reference to FIG. 1, as per Zodiac man, it has been revealed that the Zodiac constellations are coding different parts of the human body. The data points at specific parts of the body as well as certain organs. In our research, we were able to pinpoint and specify the Galactic code as related to specific systems of the human body.

The basis of the research:

Each 3 constellations are belonging to a certain element. The supposition was that the element is taking part in the construction of one body system; so all the constellations that are belonging to that element are taking part in the construction. This seems very likely as the systems of the body are usually consisting of 3 parts—the part coming with the task, which is a leading part; a part that is in the process of fulfilling this task and the ending part which is coming with a decision. In the human body the leading part that is giving a command in most cases is the brain. The signal from the brain is coming to an organ that is entering in the process of fulfilling this command. The feedback from the working organ is coming back to the other part of the brain that is analyzing the results. It is important for the leading part to know the results in order to come with improving the task, for the ending part of the brain to process the biofeedback, and for the intermediate part of the brain to understand the new leading task again. So among the constellations, the leading part that is starting the process is the Cardinal sign, the intermediate part that is fulfilling the process is the Fixed sign, and the ending part analyzing the work is the Mutable sign.

As it is shown n a Zodiac man, the constellations are running along the eclipse around the human body. The person is standing on his feet, with his head up. In our study we have shown that when the ecliptic is running around the person, it is important that the person would be standing with his body turned to the left side while the right side is facing the observer. This is important as in the movement counterclockwise the constellations are running through the back of the person, his leg, and then are coming up over the person's front and over his face and head.

This way the constellations are coding specific parts of the body. At the same time they are following each other around the human body in a regular consequence, same as they are following each other in the Zodiac ecliptic.

This way the ecliptic around the person is similar to the ecliptic in the sky around the sun. The energies of the constellations and the planets that are working in the sky are creating the blueprints for the newly born people. The blueprint depends on the energies of the planets working on the energies of the constellations in the present moment.

Each sign has a significance of reflecting a certain system in the body and reflects a psychic structure determined by this system. That means that the major concerns and conflicts for the person will be determined by the part of the biological system that is coded by this particular sign. The major conflicts are reflected by the Sun sign, the date of his person's birthday.

Signs of the Zodiac and the Systems of the Human Body.

There are 12 signs of the Zodiac and corresponding to the 4 elements. So each element is containing 3 signs of the Zodiac. In the human system the 3 parts are the part of the brain giving the command, the intermediate part, including the axonal receptors of the nervous cells, and the part of the brain finishing the process and analyzing the result. So each element of the Zodiac is connecting to the corresponding human system in 3 different parts. Each is holding the energy of the whole system, and at the same time contains a specific biological part of the system.

We will look now separately at each system. The information was obtained using the current available Zodiac man data for the combinations of the sign and the ruling its planet, as well as combining this knowledge with the modern knowledge of the medical human body structures and systems.

Because of a new meaning of the constellations that were received with the knowledge of an underlying biological structure, some of the ruling planets were reassigned.

Fire Element.

The Fire element is presented by 3 signs—Aries, being the cardinal leader sign, Leo—the intermediate fixed sign, and Sagittarius—the ending mutable sign

Aries is represented in the body by the forebrain building the parts of the brain connected to the eyes, space between thee eyes, nose, limbic system. Limbic system is the emotional brain; it represents the need for the person to have emotions and to present questions regarding oneself. The emotional brain is experiencing oneself.

The reassigned ruling planet for the sign of Aries is the moon. The moon is the planet that is experiencing and transmitting the emotions of the signs. It is also responsible for the female hormones, which influence the emotions.

The psychological conflict of Aries is to experience oneself and one's own emotions.

Leo represents the unconscious parts of the brain—parietal, temporal and occipital lobes. Those parts belong to the intermediate part of the Fire system, ruled by the sun, and allow the person to experience the creativity and potential of who he is.

The psychological conflict is to feel successful in being creative in the world and to feel as the creative potential is fully used. The Sun is containing an enormous potential, which makes it difficult to feel fully expressed and fully successful in life.

The Lion represents the king of the animal as containing an enormous potential.

Sagittarius represents the hip and the motor nuclei of the spinal brain, as well as the energy producing organs such as the liver. It means—the capacity to move and express oneself. Sagittarius is the ending part of the task to get to know and express oneself. Jupiter being its ruling planet, it has an expanded nature to express itself in the world, to be a teacher, politician, religious leader, to play different roles in the material plane. Sagittarius represents the centre of our Milky Galaxy, and its ability to expand.

The conflict of the person with a birthday in Sagittarius is when he feels he didn't express himself enough. The Sagittarius represents a person finally aiming his arrow in his chosen destination.

Jupiter, Sun and our planet Earth with the Moon representing it, are the 3 planets belonging to the Fire element and representing the Human emotions evolving on the planet Earth with the ability to feel creativity and fully express oneself.

Air Element.

The air element is represented by Libra, which is the cardinal, leading sign, the sign of Aquarius, which is the fixed intermediate sign, and the sign of Gemini, which is the ending, mutable sign.

Libra is starting the task of relationships of giving and distributing to others. In the organism it is the task of the vegetative nervous system and the 12 nerves coming from the base of the brain.

Libra represents the relationship of the nervous system with different organs and the ability to distribute to others and remember oneself at the same time.

The reassigned ruling planet is Mars. We reassigned the ruling of this sign to Mars because of Libra's connection with action. Mars in Aries on the other hand is in exile, as it takes on itself a negative quotation.

The main conflict of Libra is the desire to connect and think about others. When there is a disconnection it brings suffering.

Libra or the scales represent measuring the right amount that it supplies to oneself and others.

Aquarius represents the neuronal axons of the vessels belonging to the neuro-vegetative system. Those might contain both afferent and efferent parts of the system.

The person, whose sun sign is in Aquarius, feels like he contains a vast amount of knowledge. He is also eager for the acts of giving to others.

The ruling planet is Uranus.

The main conflict arises with the inability to give, include oneself, and the feeling of distance with other people.

Aquarius is pouring water because this sign is the closest to the water element of the constellations as it represents the vessels supplying the whole body. The ruling planet Uranus is in closest chemical and structural connection with the planet Neptune that is ruling the water constellations.

Gemini represents the frontal lobes, the chest, the arms with shoulders and hands.

Gemini is quick for thoughts and actions; he likes to spend the life outside the routine. Gemini is looking for knowledge to fuel his thoughts. Gemini represents the mutable ending results of the air system. The ruling planet is Mercury.

The main conflict is for the Gemini when he finds himself within routine problems and boundaries. Gemini also has a conflict when his thoughts seem not right or have some conflict to them.

Water Element

Cancer is representing the superconscious part of the brain, located in between the unconscious parietal lobe and the conscious prefrontal lobe. It is coding the pineal gland, which is responsible for switching the night and day. It also represents the stomach.

The role of Cancer is the recognition of the other and acceptance of him. The stomach is playing this role by reorganizing the foreign material and making it look like its own self. The recognition makes the absorption possible.

Cancers are organizing other people, giving them a friendly advice and support, as well as taking care of them.

The reassigned ruling planet is Neptune. Neptune is fulfilling the organizing role of the Cancer constellation. Neptune and the trans-Neptunian objects are responsible for the constellations that are belonging to the water element.

The major conflict of Cancer is to be closer to friends and family and less sensitive to offense, as well as the ability to put healthy boundaries. Cancers are wearing shell to be protected from offences and to have a private space.

Scorpio is representing the reproductive system. Scorpio is working on the recognition of the self and the other. On the biological level it is recognition of the antigens of the egg and the sperm and their possible connections. Scorpio is good in psychic vision and intuition. The ruling planet is Pluto. Pluto is giving the person the sparks of intuition and the feelings of the bliss and the difficulty of the personal connections.

The main conflict of Scorpio is the intensity of feelings that could be overwhelming and the turmoil of emotions of compatibility and incompatibility.

All the water signs are represented with the animals covered with the shell.

Scorpio is known that the female is eating the male partner after the fertilization of the egg. This is how the reproductive cycle is necessary and made so distinct in the example of this insect.

Pisces is the mutable sign. Pisces makes the task of interpersonal recognition and connections more intense. Pisces is representing the lymphatic system. In the lymphocyte the recognition is aimed to one antigen that is distinguishing the self from the foreign body.

This knowledge is accomplished in the organ thymus, were the lymphocytes are trained to distinguish the self and the foreign to the point that each lymphocyte can recognize and melt with a foreign body that is distinguishing from its own body just by one antigen particle. Pisces psychologically achieve the maximum compassion and personal recognition.

The reassigned ruling planet is Chiron. Chiron is responsible for the healing aspect in the relationships. Chiron belongs to the trans-Neptunian objects, that are located in the zone close to Neptune and are responsible for the healing of the relationship aspects in the constellations belonging to the water element.

Pisces is the only sign that is represented by two living beings. 2 fishes are aiming in 2 different directions showing that they have different goals and destinations but are located close to each other, showing their close interaction. They are covered with shells, which is pointing to the aspect of healing the relationships in this sign as in the other signs of the water element.

The main conflict of Pisces is the feeling compassionate and in need to console other people that may be overwhelming, as well their possible coming along inability to put healthy boundaries.

Earth Element

Capricorn is representing the skeleto-muscle system, connective tissue, hyaluronic cartilage. It's the main leading sign of the earth and the human being. Capricorn is working on designing a right project. Capricorn takes the full responsibility for the project.

The ruling planet is Saturn. In the myths Saturn is told to bring the human in the Galaxy and connect it to Capricorn.

The main conflict of the person born in Capricorn is related mainly to study and work.

Capricorn is known for its love to jump and run which is connected to the work of the skeletto-muscular and connective tissue. Capricorn is known for its legs and joints and for its desire to do things in its own way.

Taurus is representing the throat, face and the 5 senses. Taurus is working on maintaining things in the right way, enjoying the senses and learning to recognize a better way to accomplish things in life. Taurus as a Capricorn is known for the desire to do things in its own way, learning and loving the process to distinguish the right from wrong.

The ruling planet is Venus. The main conflict of Taurus is to enjoy and be grateful to things in life.

Taurus is having a bull face that is representing that Taurus is covering the face and the senses.

In the Greek mythology the goddess Venus is appearing once as a bull.

Virgo is representing the cerebellum. Virgo is working on the ability to analyze how things are done, in a right or wrong way. Virgo is concerned about the details of how things are done.

Virgo is the only constellation in the Zodiac that is not having its own ruling planet. Contrary to other constellations belonging to the earth element it is ruled by the planets belonging to the trans-Neptunian objects and by the Uranus.

The ruling planets are Uranus and Pluto.

Uranus is giving the person a psychic aura. Pluto is giving Virgo the moments of utmost understanding, personal connections and bliss.

Virgo is the only constellation that has planets that are not belonging to the element of the constellation

The planet ruling the signs of the water element Pluto is uniting with the planet ruling the signs of the air element—Uranus, these 2 forces together are giving the constellation of Virgo the qualities necessary for making the person a divine being.

This way there are only 11 planets that are ruling the 12 constellations of the Zodiac that are coding the energies for the human being.

The main conflict of Virgo is being very particular to how things are done.

Virgo represents the virgin from the Greek mythology. The virgin Persephone was the daughter of Zeus(Uranus) and the wife of Hades (Pluto). She was abducted by Hades and was spending 6 months on the Earth and 6 months in the underworld.

Persephone is representing the higher achievement of the human being to be with God. God takes the rulership over the cerebellum to be with the human being and show the way back to the divine.

16. The Solar System and the Process of Evolution.

The Water Constellations and the Beginning of the Life Cycle.

The life started outside of the Solar system in the Divine space. The first living beings were born in the water. Neptune, the planet with the icy water structure with the trans-Neptunian objects around it seems to be the planet that had ruled the constellations that gave birth to a first living being. Constellation of Cancer that is organizing the activities and pointing towards Sirius at 15 degrees is the water constellation that could be the giver to the living being.

Cancer is responsible for the work of the stomach that was the first organ to appear in the living cell and was providing nutrients for the whole system. The stomach is taking the foreign material from outside of the cell and transforming it into the nutritional material accepted by the cell. This is done by hormonal systems of the stomach, including the H-pump.

Cancer is also responsible for some parts of the brain responsible for life important functions—pineal gland, that is switching the biorhythm for the day and night cycle.

The other planets of the trans-Neptunian objects are helping with the other major functions of the living systems—reproductive and protective functions. The planet that is responsible for the reproductive function is Pluto, it is ruling the constellation of Scorpio, and for the protective function—Chiron, it is ruling the constellation of Pisces. The constellations of Scorpio and Pisces are also belonging to the constellations of the water element. Scorpio is responsible for the reproductive function of the living system that is the process of accepting the foreign material as well and melting with it into one. Recognizing the foreign material performs the protective function ruled by the constellation of Pisces. It is performed by the cells of the immune system which after recognizing the material differing from the native material by one particle (antigen) are melting with it to eliminate.

All the processes of digestion, reproduction and protection are completed by the means of the secreted substances—hormones. While the stomach is just changing the foreign material by one particle, the immune system is working with the substances differencing from the native material by one particle.

The reproductive function is getting more complicated with the appearance in the mammals of the intrauterine pregnancy which is accepting the foreign particles (antigens) for several months. So the signs of the water element are operating on the level of the recognition and compassion. The work is done by the use of the secretary substances—hormones.

The Involvement of the Uranus and the Air System.

Uranus is the next planet that is getting involved in the construction of the living systems after the Neptune and the trans-Neptunian objects. Uranus is the planet that is located next to Neptune and is consisted also of an icy structure, with the chemical structure rich in nitrates.

Uranus is helping also with the water structures—the vessels. The vessels are carrying the nutrients to all the organs and structures of the living being. They are being richly supplied by the nerve endings. The nerve endings are carrying the functions of sensitivity and recognition as well as carrying certain stimulus to the vessels, endothelial and smooth muscle cells surrounding them, for the performance of functions. The vessels are performing the work of support and connection. This is the function of the neuro-vegetative system.

Uranus is ruling the constellation of Aquarius that is carrying the knowledge of support for the whole system of the living being. It belongs to the element of Air.

The other constellations that are belonging to the element of Air are Libra and Gemini. All the constellations belonging to the element of Air are carrying the function of connection and support.

The new more organized organisms that appear after the influence of the Uranus may be still living in the water. Uranus is preparing the grounds for the appearance of the new living beings that are capable of living on the ground and are having the tools of moving on the ground—the skeleto-muscle system.

This system is appearing with the involvement of the planet Saturn.

The Involvement of Saturn and the Earth System.

Saturn is the next planet that is partaking in the development of the living being.

Saturn gives rize to the skeleto-muscle system of the living beings and to the kingdom of the Vertebrates.

The appearance of the Vertebrates lead to the development of the major systems—the cardio-respiratory, metabolic, hemopoetic, reproductive.

All those functions were fulfilled with the participation of the planets of the Solar system. Saturn differs from the structure of the icy planets. It is firm and structured.

Saturn is ruling the constellation of Capricorn, that belongs to the element of Earth.

The other constellations that are belonging to the element of Earth are Taurus and Virgo.

The skeleto-muscle system is performing the work of design and construction.

The Involvement of Jupiter and of the Fire System.

Jupiter is the next planet after Saturn towards the Sun. It is ruling the constellation of Sagittarius that is considered to be Centre of the Milky way Galaxy to which the solar system belongs. Jupiter is an expansive planet of the highest diameter of all the planets of the solar system. Jupiter is helping the Vertebrates to gain all the necessary functions that will lead them into development into higher vertebrates, primates and humans. It helps with the acquirement of the metabolic functions necessary to move the muscles, the glands and hemopoetic organs necessary to supply the oxygen to the organs and the complicated nervous system that is achieving the interaction between the different body parts and the organs, as well as the complicated central Nervous System—the Neocortex.

The constellation of Sagittarius is ruling the hip, where the motor energy collecting in the nuclei of the spinal cord are reorganizing in the work of the muscles. It is also ruling the work of the liver with its metabolic function that is providing the energy for the work of the muscles. Jupiter is responsible for the work of the pituitary gland which is controlling the reproductive organs, the uterus, the thyroid function.

The other constellations belonging to the Fire element are Leo and Aries.

Those two constellations are ruling the parts of the Neocorex. The constellation of Aries rules the emotional brain—the limbic system, the constellation of Leo rules the unconscious parts of the Central Nervous System—the parietal, temporal and occipital lobes.

The Neocortex of the Fire system, the metabolic system and the motor system of the spinal brain are carrying the functions of self-expression.

Saturn and Jupiter are belonging to the social planets of the solar system. They are supplying the living system with all the necessary parts and organs for construction and self-expression.

The Involvement of the Personal Planets and the Moon.

### Mars.

Starting with Mars all the planets are called the personal planets and are ruling the systems, which are characteristique for mammals and humans.

Mars is the next planet towards the sun after Jupiter. It rules the constellation of Libra. (The ruling for some planets—Mars, Moon and Neptune is changed. The changes are described in this manuscript.)

Libra is the constellation belonging to the Air element and responsible for the relationship between the different parts and organs of the living system.

Libra is the part of the vegetative nervous system that is responsible for the innervations of the body for the performance of the body functions.

Libra was considered as 12 brothers or the 12 titans. Those are the 12 nerves that ae coming from the base of the spine. Most of the nerves are coming from the nuclei that are belonging to the medulla oblongata.

The constellation of Libra is regulating the kidneys and adrenals, the flight and fight response of the body to different emotions. This is the major response for the Higher Vertebrates—the mammals and the humans. Mars is regulating the major actions of the body and the male hormones.

Mars is the planet that is rich in iron and sulfates. Iron is necessary for the hemopoetic organs and has been used for carrying the oxygen by the red blood cells—erythrocytes. The sulfates are used for the interaction with the connective tissue. Many of the interactions with the organs are happening through the interactions with the connective tissue, which is surrounding the organs.

Mars is interacting with Venus in the construction of the throat cartilage and the vocal cords. Those constructions are different for the male and female bodies.

Mars and Venus are also exchanging the nervous fibers that are controlling the 5 senses. Venus is offering the senses of taste and smell, and Mars is ruling the fibers carrying the sense of touch.

Mars is possibly belonging to the air system as it is ruling the constellation belonging to the Air element.

The consciousness of Mars is connected with the development

### The Earth and the Moon.

The planet that is showing the role of the earth for the evolution of the living being is the Moon.

The Moon rules the constellation of Aries (this is a new ruling assigned to the planet, as it was for Mars and Neptune).

Aries is the constellation that is belonging to the element of Fire. It rules the emotional brain—the limbic system. The limbic system is responsible for feeling, memorizing and expressing different emotions.

The constellation of Aries is located on the same axis with the constellation of Libra. The sensing of the emotions is expressed in the actions of the vegetative nervous system and in the fight and flight response of the kidneys and adrenal, as well as on the reproductive and immune system, by acting on the production of the sexual and corticosteroid hormones.

The constellation of Aries and the development of the limbic system in the early childhood is influenced strongly by the constellation of Libra as the interaction between the parents and the child and the habits and skills of interaction that are learned by the child from the interaction with the close family.

This way the emotional brain is very important for the person, it is the main consciousness of the human being as it is reflecting the consciousness of the planet Earth itself.

The location of the moon in the sky, its phases and its consciousness is important to the person as it is reflecting his own consciousness.

The main function of the constellation of Aries and the moon as the Fire element is self-expression.

The planets that are belonging to the Fire element are expansive—like Jupiter and the Sun. The Earth is expansive with the colors and life visible to the human eye and unique among all the planets.

The consciousness of the Earth is connected with the development of the Human being.

### Venus.

Venus rules the constellation of Taurus.

The constellation of Taurus and Venus are belonging to the element of Earth.

The main function of the constellation of Taurus as belonging to the Earth element is designing and maintaining It rules the face with the 5 senses and the throat.

The main function of the throat and face is to construct the world with the words and enjoy the world with the senses. Love becomes something constructed by the person himself. The role of Venus is to enjoy both positive and negative in the world.

Venus is responsible for the unique gland thymus that is building the lymphocytes, encounting in their development both negative and positive influences that are necessary for their maturation. The consciousness of Venus is the higher consciousness of the 5^{th} dimension of love, which can tolerate good and bad as being perfect.

### Mercury.

Mercury rules the constellation of Gemini, which is located next to the left side of the Cancer in which the summer solstice occurs and which is on the top of the astrological chart. The constellation of the Gemini belongs to a conscious world.

The constellation of Gemini and Mercury are belonging to the element of Air.

It rules the conscious brain—the frontal lobes with their executive function, the rib cage, the shoulders, the arms and the hands.

The main function of the constellation of Gemini, as belonging to the air element, is to connect and support.

### Sun

Sun rules the constellation of Leo, which is located next and to the right side of the cancellation of Cancer. The sun is in its Zenith on the top of the chart and is at home in the constellation of Leo. The constellation of Leo belongs to the unconscious world.

The sun is representing the all-creative and all-encompassing nature of the human being, which he recognizes. It rules the parietal, temporal and occipital lobes of the human brain.

The constellation of Leo and the sun are belonging to the Fire element.

The main function of the constellation of Leo as belonging to the Fire element is self-expression.

### The Constellation of Virgo.

The only constellation that is not having a typical ruling planet is Virgo. Virgo gets the ruling of 2 planets of the Air and Water—Uranus and Pluto.

These planets are presenting the constellation of Virgo with the divine qualities—independence, knowledge, saviness, and the bliss of relationships.

In Virgo the human earthly element touches the divine.

The constellation of Virgo is located nest to the constellation of Leo—the home of the Sun. It represents the brain, and as the sun is located on the right hand of the constellations of the Cancer, which is on top of the chart. The signs located on the right side are representing the unconscious processing of their destination, to the left—the ones that need to step on the conscious path.

The main function of the constellation of Virgo is to achieve the best way and destination by analyzing each detail on its path. As in a constellation of Leo, a lot of work is done unconsciously.

The ecliptic around the person is similar to the ecliptic planets of the Solar system in the sky.

The constellations of the equinoxes are located in the narrow part of the ecliptic. The constellations of the summer signs are the closest to the Sun in its Zenith. The constellations of the winter signs are the furthest on the ecliptic around the Sun. They are leading more in the centre of the Milky Galaxy, towards the sign of Sagittarius where the Fire element system starts and the Capricorn where the Earth Human element system starts.

The action of the on the constellations is changing the energetic blueprint.

There are 11 ruling planets that are working on 12 constellations. The whole number of the possible energetic blueprints this way is 11 in the 11 degree, multiply 12

This combination number can be compared to the combination number in the biological code—3 in the 3 degree, multiply 4—108, this is multiplied 12—the number of chromosomes.

The method of the present invention specifically includes one or more of the following steps: reading a person's astrological chart using new techniques disclosed in this Application, recognizing the trio combinations of the constellations in the astrological chart, observation of the crosses formed by the constellations in the astrological chart, reading of the astrological chart as a development of consciousness from below to above, classification of the groups formed by the constellations in the chart, reading of the chart using the axes of the constellations forming a cross, utilizing the new reading of the chart in a clockwise direction to understand the interaction of the biological systems in the person's body, correlating between the elements and the constellations of the Zodiac and the biological systems of the person's body, classifying the constellations regarding to their location around the coded parts of the person's body, determining the correlation between the constellations of the Zodiac in the chart and the planets of the Solar system, using the science of astronomy of the Solar System to help to determine the relation of the person's living system and the development of the glands and/or bone systems in the person's body, evaluating the condition of the person's biological and psychological systems through the use of the astrological chart, using the new readings of the astrological chart and the personal data (birthday) of the person for the prophylaxis and the systemic development of the biological and psychological systems of the person, prescribing the recommended prophylactic treatment, and/or implementing the recommended prophylactic treatment.

While the method of diagnostic and prophylactic treatment of the present invention have been shown and described in accordance with the preferred and practical embodiments thereof, it is recognized that departures from the instant disclosure are contemplated within the spirit and scope of the present invention. Therefore, the true scope of the invention should not be limited by the abovementioned description of the preferred embodiment since other modifications may become apparent to those skilled in the art upon a study of the drawings, description, explanations, and specifications herein. Various modifications to these embodiments will be readily apparent to those skilled in the art, and the principles described herein can be applied to other embodiments without departing from the spirit or scope of the invention and the subject matter of the present invention.

What is claimed is:

1. A method of using astrological charts in the medical practice, comprising one or more of the following steps:
a. reading a person's astrological chart using techniques disclosed in this Application;
b. recognizing combinations of constellations in the person's astrological chart;
c. observing one or more cross formed by the constellations in the person's astrological chart,
d. reading the person's astrological chart as a development of consciousness;
e. classifying groups formed by the constellations in the person's astrological chart;
f. reading person's astrological chart using the axes of the constellations forming the one or more cross;
g. utilizing the reading of the person's astrological chart in a clockwise direction to understand the interaction of biological systems in the person's body; and
h. correlating between the elements and the constellations of the Zodiac and the biological systems in the person's body.

2. A method of claim 1, further comprising:
a. classifying the constellations according to their location around the coded parts of the person's body:
b. determining the correlation between the constellations of the Zodiac in the person's astrological chart and the planets of the Solar system;
c. determining the relation of the person's living system and the development of the glands and/or bone systems in the person's body using the science of astronomy of the Solar System;
d. evaluating the condition of the person's biological and psychological systems through the use of the person's astrological chart; and
e. using the new readings of the person's astrological chart and the personal data (birthday) of the person for the prophylaxis and the systemic development of the biological and psychological systems of the person, prescribing the recommended prophylactic treatment, and/or implementing the recommended prophylactic treatment.
